(19) United States
(12) Patent Application Publication
(10) Pub. No.: US 2005/0250082 A1
(43) Pub. Date: Nov. 10, 2005

(54) Interpersonal cognition method and system

(76) Inventors: Mark Baldwin, Montreal (CA); Jodene Baccus, Montreal (CA); Stephane Dandeneau, Montreal (CA); Maya Sakellaropoulo, Westmount (CA)

Correspondence Address: GOUDREAU GAGE DUBUC, 800 PLACE VICTORIA, SUITE 3400, MONTREAL, QUEBEC, H4Z 1E9, CA

(21) Appl. No.: 11/122,091

(22) Filed: May 5, 2005

Related U.S. Application Data
(60) Provisional application No. 60/567,813, filed on May 5, 2004.

(51) Int. Cl. G09B 19/00

(52) U.S. Cl. 434/236

(57) ABSTRACT

A method and a system for modifying interpersonal cognition, which allow cognitive patterns to be modified through a repetitive interaction, the method comprising for example conditioning the user to positively associate an interpersonal feature with a distinctive signal; training the user in a procedural learning process via a repetitive practice; and inducing self awareness in the user, or a combination thereof. The system may comprise means for displaying a plurality of personal features and portraits to the user; selection means allowing the user to select his own personal feature among the plurality of personal features displayed; and a means for triggering a specific interpersonal image in response to the user selecting his personal feature.

### CROSS REFERENCE TO RELATED APPLICATIONS

This application is a claims priority on U.S. provisional application No. 60/567,813, filed on May 5, 2004. All documents above are herein incorporated by reference.

### FIELD OF THE INVENTION

The present invention relates to interpersonal cognition. More specifically, the present invention is concerned with a method and a system to modify interpersonal cognition, with effects on emotion, motivation, and identity.

### BACKGROUND OF THE INVENTION

Cognitive methods using a computer are known, for example in flight training, in educational software for children, or for the treatment of phobias.

Dijksterhuis (Journal of Personality and Social Psychology, 2004, Vol. 86, No. 2, 345-355), and Riketta et al. (European Journal Of Social Psychology, Eur. J. Soc. Psychol. 33, 679-699, 2003), for example, show that associative conditioning paradigms can be used to associate positively valenced words to the self, with short-term effects on self-esteem.

MacLeod et al. (Journal of Abnormal Psychology, 2002, Vol. 111, No. 1, 107-123) point out that attention training can be used to induce and reduce attentional bias toward threatening stimuli.

In the field of interpersonal cognition, it has been shown by the present inventors that it is possible to momentarily modify people's interpersonal expectations, such as, for example, a perception of rejection, and that it is possible to use a conditioning method to associate thoughts with a neutral stimulus, in such a way, for instance, that a computer tone may lead people to expect to be accepted/rejected.

Currently, methods for modifying interpersonal cognition comprise reading self-help books; seeking psychotherapy or even anti-depressant medication. All of these methods can be successful, but often at a significant expense. Moreover, they are fundamentally limited because they are focused primarily on conscious processes or neurotransmitter levels rather than specific automatic and unconscious habits of thought.

### SUMMARY OF THE INVENTION

More specifically, in accordance with the present invention, there is provided a method for modifying interpersonal cognition of a user, comprising at least one the steps of conditioning the user to positively associate an interpersonal feature with a distinctive signal; training the user in a procedural learning process via a repetitive practice of the step of conditioning; and inducing self awareness in the user.

There is further provided a system for modifying interpersonal cognition of a user, comprising means for displaying a plurality of personal features and portraits to the user; selection means allowing the user to select his own personal features among the plurality of personal features displayed; and means for triggering a specific interpersonal image in response to the user selecting his personal feature with the selection means.

Other objects, advantages and features of the present invention will become more apparent upon reading of the following non-restrictive description of embodiments thereof, given by way of example only with reference to the accompanying drawings.

### BRIEF DESCRIPTION OF THE DRAWINGS

In the appended drawings:

FIG. 1 illustrates an interface of a game according to an embodiment of the present invention;

FIG. 2 illustrates an interface of a game according to another embodiment of the present invention;

FIG. 3 illustrates an interface of a game according to still another embodiment of the present invention; and

FIG. 4 illustrates an alternative of the game of FIG. 2.

### DESCRIPTION OF EMBODIMENTS OF THE INVENTION

There is provided a method and a system for modifying interpersonal cognition, which allow cognitive patterns to be modified through a repetitive interaction.

It is known that the human personality, including a person's information processing and self-regulatory capabilities and styles, is given form by cognitive-interpersonal-motivational structures of the mind. Representations in the brain that underlie mental structures can be modified according to principles of learning theories, as supplemented by cognitive and social cognitive science. Such representations include self representations, person representations, and interpersonal representations, as well as procedures for manipulating information.

The present method allows conditioning automatic and unconscious habits of thought of a user in a way that affects the user's cognitive patterns, for example boosting the user's self-esteem and emotional wellbeing.

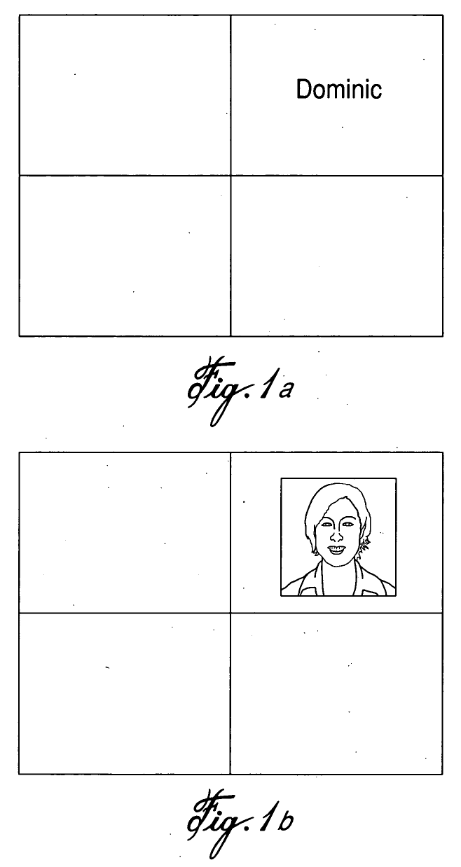

The method may comprise conditioning the user to positively associate an interpersonal feature with a distinctive signal, such as a tone, image, or aspect of a self-concept, for example, by an associative learning process via a repetitive pairing of stimuli. As illustrated in FIG. 1, the user may thus be offered to play a game for example, wherein the user is led to select his own name among a number of names and portraits, and wherein a hit, i.e. selection of his name, triggers a specific interpersonal image. The user is then trained into associating a self reflection with a distinctive image, which may be selected so as to be positive.

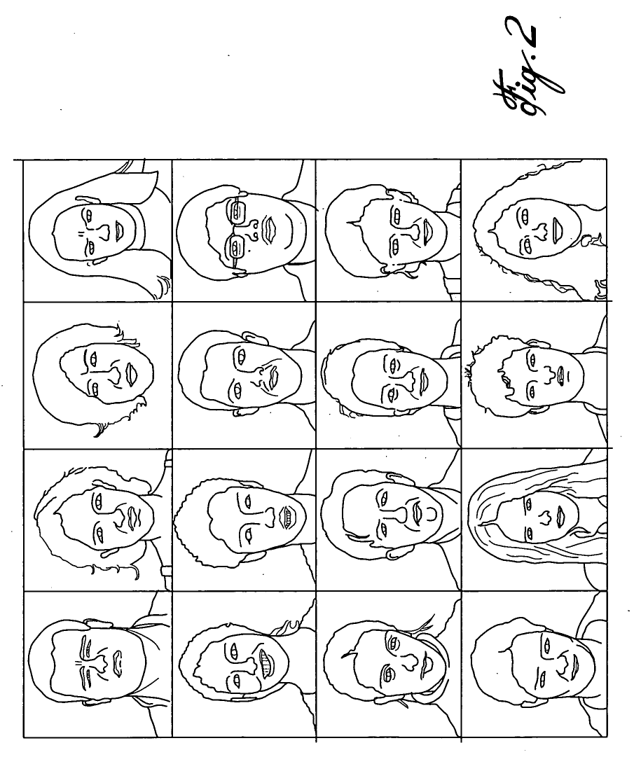

The method may further comprise training the user in a procedural learning process via a repetitive practice of a skill or operation, including the activation or inhibition of specific types of representations, for example to ignore negative signals and to focus on positive signals. As illustrated in FIG. 2, the user may thus be offered to play a game for example, wherein the target is to localize as quickly as possible a smiling portrait among stern portraits. The user is then trained into ignoring negative reflective signals such as a stern face and to tending to direct his/her attention to positive reflective signals such as a smiling face.

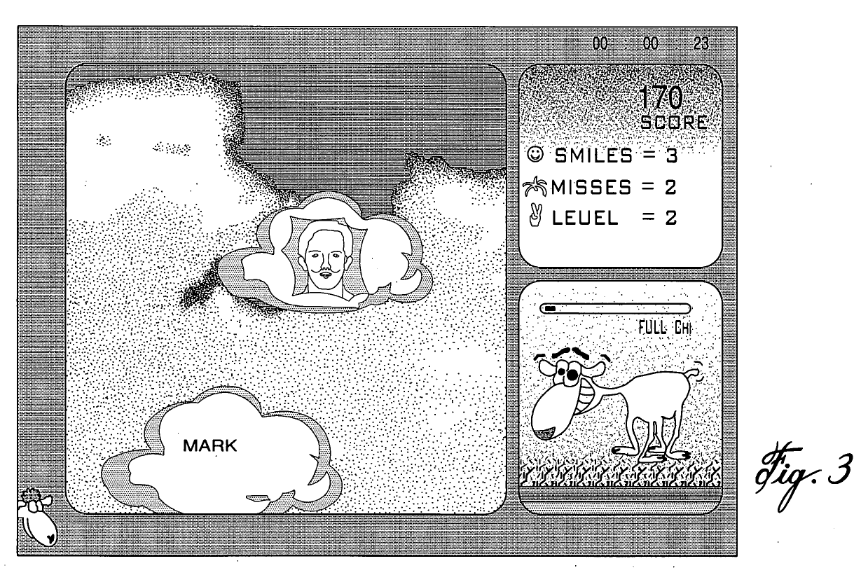

Moreover, the method may comprise inducing self awareness in the user, by granting the user with personal feed back. For example, as illustrated in FIG. 3, in the games described hereinabove, a feature such as the user's name or image, a blinking eye, or a face making eye contact with the user, or even a personalised increasing score may be provided to create a relationship with the user and induce self-awareness.

The method may also comprise at least one of the following steps: modifying levels of the chronic accessibility of a representation (for example a specific self-representation or interpersonal representation) via repetitive activation or inhibition; structuring information by relating it to pre-existing structures (for example, the self-concept) or by organizing it into narrative form (for example, the self-narrative); creating, strengthening, or weakening associations of information to the self-concept via the manipulation of activation levels in the objective and agentic aspects of the self-concept; creating, strengthening, or weakening procedural learning relevant to specific motivations (for example for interpersonal connectedness, status, or agency), via the practicing of intentions and the linking of intentions to motivational, interpersonal, and self representations; resolving conflicts in goal structures by modifying associations and/or procedures; weakening associations, procedural learning, and related memory representations via the blocking of reconsolidation of memory; and applying neuropsychological interventions to improve the encoding of new learning, or to induce motivational and/or affective states relevant to the desired learning.

These steps may be applied independently or interdependently and synergistically with the purpose of producing a desired change in cognitive structures.

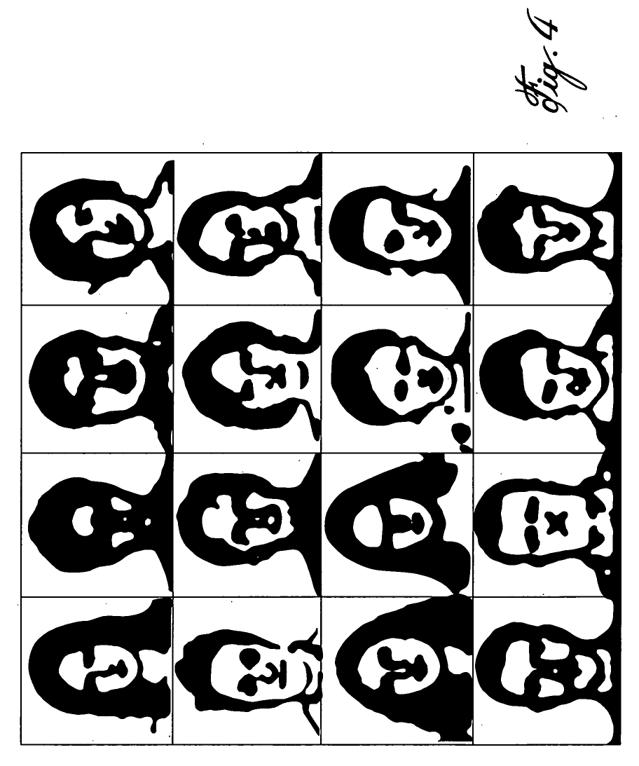

The present method is shown to reduce low self-esteem individuals' attentional bias toward rejection. This bias is measured using reaction-time tests, for example a test in which people have to name the colors in which different words are displayed on a screen. Low self-esteem people tend to be distracted when a word relating to rejection appears, which indicates that their attention is drawn toward social threats, and they find it difficult to disengage from them, but this effect is not there if they previously played a game as described hereinabove for five minutes. Such interpersonal conditioning games as described hereinabove increase implicit self-esteem, particularly among low self-esteem individuals, and they also reduce feelings of aggressiveness among low self-esteem individuals. A game with degraded images of faces has further been used, to assess whether emotion-processing areas of the brain are more sensitive to and influenced by emotional stimuli when distracting information such as skin color and facial details for example are removed or obscured (see FIG. 4). This study showed higher implicit self-esteem among people using this game, compared to control condition.

Such interpersonal conditioning games as described hereinabove are shown to reduce attentional bias toward social rejection, presented to the left visual field, indicating an involvement of the right amygdala, which is known as a part of the brain involved in negative affect. In a study, telemarketers were offered to play such a game each workday morning for a week, in two groups, including a placebo group. Self-esteem and stress were measured daily, and the group that applied the method as described hereinabove displayed higher self-esteem and lower stress than the placebo group. At the end of the week, the level of cortisol, known as one of the major stress hormones, was measured in their saliva. The group that applied the method as described hereinabove showed lower cortisol than the placebo group. High levels of cortisol are known to put people at risk for developing various medical problems. Also, the group that applied the method as described hereinabove had higher self-ratings of agreeableness and higher sales performance than the placebo group. This study further shows that the effect of the present method lasts at least across a seven hour work day, from playing the game in the morning to answering the questionnaires at the end of the day, and that the effects persist across the entire week.

A tone-conditioning method as previously described is shown to be effective in modifying people's motivational orientation toward a novel activity. Subjects were trained to associate a tone with either highly controlling or highly choice-supportive interpersonal feedback. As they were then engaged in a subsequent activity, one of the tones was played repeatedly. People who heard a same tone that had earlier been paired with controlling feedback appeared to be less interested in the new task than those hearing a tone that had earlier been paired with choice-supportive feedback.

The present method was also tested with children aged 12-15, showing effects of increased self-reported feelings of self-liking, known as a component of self-esteem.

The present invention further provides a system for modifying interpersonal cognitive patterns. Basically, the system comprises a means for repeatedly performing a task or an activity according to the above described method.

For example, the task may be a game the user may play, and leading the user to repeat some of the steps listed hereinabove. Such a game may be offered as computer software and made available to a number of users over the Internet, as a box set, or pre-installed on various hardware devices. They may be played on a computer, or on any number of handheld devices during brief breaks during the day.

The present system is effective for the user. It may be used for example to increase the self-esteem and emotional security of the user playing it.

As people in the art will appreciate, the method and system of the present invention involve the application of well-established learning principles in an entirely new way, to induce modifications of interpersonal- and self-cognitive patterns of the user, thereby allowing for example the user to feel more securely accepted by others, by allowing a direct modification of automatic and unconscious habits of thought via repetitive practice.

The cognitive functions that may be modified by the present method include for example the following:
Secure base: maintaining a sense of basic trust and security in the world and one's social relations, via positive expectancies, object representations, working models, and transitional objects. In this case, the method comprises increasing a relative activation of positive expectancies about others' availability and responsiveness, particularly contingent on personal stress, failure, or need states.
A sense of identity encompassing narrative, metaphoric, and mythic processing. In this case, the method comprises using metaphor to promote activation and then integration of separate and interdependent aspects of an agentic and interpersonal self.
A functional self-system, including representations, ego functions, and social skills, that facilitates meeting needs at both intrapsychic and interpersonal levels, in the user's interpersonal and cultural milieu. In this case, the method comprises training and strengthening a set of ego functions such as self-discipline, observing ego, self-transcendence, self-esteem, commitment, coping responses, inhibition of disturbing information, self-regulation and self-regulatory resources, established via practice and internalization of external structures.
A motivational and representational system that provides an experience of purpose, hope, meaning, value, and security. In this case, the method comprises training and strengthening a set of self-regulatory functions that facilitate the satisfaction of needs and motives including agency, communion, autonomy, relatedness, power, intimacy, competency, control, status, dominance, belonging, intrinsic motivation, dependency, attachment, authenticity (with motives conceptualized at a psychological and also neurological level), while avoiding, overcoming, or negotiating situations of motivational conflict.

The present method may modify these general cognitive processes by a number of targetted actions, applied within or outside of the conscious awareness of the user, including for example:
a strategic activating and/or inhibiting of target types of information;
modifying associations, via pairing, reinforcement, and extinction procedures, which may comprise manipulating brain states;
training of cognitive operations or procedural knowledge, including if-then inference procedures, attention deployment, analogical thinking, discrimination and compartmentalization versus overgeneralization, and counterfactual thinking;
modifying a motivational structure, including manipulating a regulatory focus, behavioral activation and inhibition systems, need for structure, implementation intentions and commitment to facilitate goal pursuit; and
modifying self-relevant processing, by manipulating levels and forms of self-awareness, action identification, self-evaluation, and mentalizing about one's own and other's mental states.

People in the art will appreciate that, in contrast to currently available methods and systems for modifying interpersonal cognition, the present method and system may be simultaneously accessible to a number of users, at a relatively low cost, and allow a focus on automatic, unconscious patterns of thought.

Although the present invention has been described hereinabove by way of embodiments thereof, it may be modified, without departing from the nature and teachings of the present invention as described herein.

1. A method for modifying interpersonal cognition of a user, comprising at least one of the steps of:
conditioning the user to positively associate an interpersonal feature with a distinctive signal;
training the user in a procedural learning process via a repetitive practice of said step of conditioning; and
inducing self awareness in the user.

2. The method according to claim 1, wherein said step of conditioning the user to positively associate an interpersonal feature with a distinctive signal comprises conditioning the user to positively associate an interpersonal feature with one of a tone, an image, and an aspect of a self-concept.

3. The method according to claim 1, wherein said step of training the user in a procedural learning process comprises at least one of a substep of activating and a substep of inhibiting target types of representations.

4. The method according to claim 3, wherein said at least one subset of activating and inhibiting target types of representations comprises training to ignore negative signals and to focus on positive signals.

5. The method according to claim 1, wherein said step of inducing self awareness in the user comprises granting the user with personal feed back.

6. The method according to claim 1, further comprising at least one of the steps including:
modifying levels of a chronic accessibility of a representation via one of a repetitive activation and a repetitive inhibition;
structuring information by one of relating the information to pre-existing structures and organizing the information into a narrative form;
at least one of creating, strengthening and weakening associations of information to a self-concept via manipulating activation levels in objective and agentic aspects thereof;
at least one of creating, strengthening and weakening procedural learning relevant to target motivations, via practicing of intentions and linking thereof to motivational, interpersonal, and self representations;
resolving conflicts in goal structures by modifying at least one of associations and procedures;
weakening at least one of associations, procedural learning and related memory representations via blocking reconsolidation of memory; and
at least one of improving an encoding of new learning and inducing at least one of motivational and affective states relevant to a desired learning.

7. The method according to claim 1, affecting a cortisol level of the user.

8. A system for modifying interpersonal cognition of a user, comprising:
means for displaying a plurality of personal features and portraits to the user;
selection means allowing the user to select his own personal features among the plurality of personal features displayed; and
means for triggering a specific interpersonal image in response to the user selecting his personal feature with said selection means.

9. The system according to claim 8, wherein said means for displaying a plurality of personal features and portraits comprises means for displaying names and a plurality of smiling portraits and of stern portraits, said selection means allowing the user to localize his own name and one of the plurality of smiling portraits among the plurality of stern portraits.

10. The system according to claim 8, further comprising means for producing a feedback to the user.

11. The system according to claim 10, wherein said means for producing a feedback comprises means for displaying at least one of the user's personal feature, the user's portrait, a blinking eye, and a face making eye contact with the user.
